(19) United States
(12) Patent Application Publication
(10) Pub. No.: US 2007/0005586 A1
(43) Pub. Date: Jan. 4, 2007

(54) Parsing culturally diverse names

(76) Inventors: Leonard Arthur Shaefer JR., Ashburn, VA (US); Richard Gillam, Herndon, VA (US); Frankie E. D. Patman, Bethesda, MD (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/092,991

(22) Filed: Mar. 30, 2005

Related U.S. Application Data
(60) Provisional application No. 60/557,392, filed on Mar. 30, 2004.

(51) Int. Cl. G06F 17/30

(52) U.S. Cl. 707/5

(57) ABSTRACT

A disclosed parsing system automatically parses culturally diverse names using culture-specific parsing algorithms. The culture-specific parsing algorithms may use statistical information describing name phrases of the name to separate the name phrases into a title, a given name, a surname, and a qualifier. In one or more systems, the validity of a parse of a name is determined, and names for which an invalid parse has been generated may be parsed again. Multiple names indicated by a conjoined name construct may be parsed individually. Name phrases that may include multiple tokens of a name are identified and used as a basis for parsing and other processing of the name.

### CROSS REFERENCE TO RELATED APPLICATIONS

This application claims the benefit of U.S. Provisional Patent Application Ser. No. 60/557,392, filed on Mar. 30, 2004, and titled “Parsing Ethnically Diverse Names,” the entire contents of which are hereby incorporated by reference for all purposes. This application is related to U.S. application Ser. No. 09/275,766, filed on Mar. 25, 1999, and titled “System and Method for Adaptive Multi-Cultural Searching and Matching of Personal Names,” the entire contents of which are incorporated by reference in its entirety for all purposes.

### TECHNICAL FIELD

This document relates to processing names in general, including parsing personal names that are representative of multiple cultures.

### BACKGROUND

Culturally diverse names may be parsed differently, despite having similar syntactic characteristics. For example, in an English name that includes three tokens, the first two tokens typically represent given names, and the last token typically represents a surname. However, in names of other ethnicities, the middle token may represent a qualifier for the last token, so the first token may represent a given name, and the last two tokens may collectively represent a single surname. As another example, a given name typically precedes a surname in an English name, while a surname typically precedes a given name in an Asian name. For these and other reasons, parsing a group of names correctly and consistently can be difficult, particularly when names within the group represent multiple cultures.

### SUMMARY

A disclosed parsing system automatically parses culturally diverse names using culture-specific parsing algorithms. A culture of a name to be parsed is identified, and statistical information describing constituent name phrases is identified. A parsing algorithm that is specific to the identified culture classifies each of the name phrases based on the statistical information. The parsing system determines whether the classification of the name phrases represents a valid parse of the name. If the parse is not valid, then the name is parsed again to produce a different parse.

In one general aspect, parsing names includes enabling access to multiple parsing algorithms for parsing name elements into one or more types of elements. The multiple parsing algorithms include separate parsing algorithms that respectively correspond to at least one of multiple known cultures. A name that includes one or more elements is received, and an indication of at least one culture from among the multiple known cultures is accessed for the name. One of the multiple parsing algorithms is selected based on the indication of the culture of the name. The one or more elements of the name are parsed into element types using the selected parsing algorithm, and an indication of the element types of the one or more elements is provided.

Implementations may include one or more of the following features. For example, accessing the indication of the culture of the name may include detecting a characteristic of at least one of the elements of the name. The indication of the culture of the name may be determined based on the characteristics detected.

A database providing a statistical indication of a type of an element may be accessed. Parsing also may be based on the statistical indication.

A validity score for the parsing of the elements may be determined. The validity score may be compared to a threshold. Whether to reorder the one or more elements may be determined based on a result from the comparing. For example, a determination to reorder the one or more elements may be made based on the validity score. A database providing statistical indications of the types of the one or more elements may be accessed, and the one or more elements may be reordered using the statistical indications. The reordered elements of the name may be parsed into element types using the selected parsing algorithm. An indication of the validity score may be provided.

Parsing the one or more elements of the name into element types may include classifying each of the one or more elements as a title, a given name, a surname, or a qualifier. Statistics describing at least one of the one or more elements of the name may be provided. Receiving the name may include receiving a personal name.

In another general aspect, identifying a valid parse of a name includes receiving a name that includes one or more elements. The one or more elements of the name are parsed into element types. Whether the element types of the one or more elements represent a valid parse of the name is determined, and an indication of whether the element types of the one or more elements represent a valid parse of the name is provided.

Implementations may include one or more of the following features. For example, determining whether the element types represent a valid parse of the name may include determining a validity score for the element types. The validity score may be compared to a threshold. Whether to reorder the one or more elements may be determined based on a result from the comparing. For example, a determination to reorder the one or more elements may be made based on the validity score. A database providing statistical indications of the types of the one or more elements may be accessed, and the one or more elements may be reordered using the statistical indications. The reordered elements of the name may be parsed into element types using the selected parsing algorithm.

In another general aspect, processing a name includes receiving an indication of a name that includes multiple tokens. An indication of a culture of the name is accessed. One or more name phrases included in the name are identified based on the culture of the name. At least one of the identified name phrases has more than one token. The identified name phrases is designated as an input to a subsequent name processing operation, and the name is processed using the identified name phrases as an input to the subsequent name processing operation.

Implementations may include one or more of the following features. For example, processing the name may include parsing the name.

Identifying the one or more name phrases may include classifying each of the multiple tokens in the name as a prefix, suffix, or stem based on the culture of the name. The classified tokens may be grouped into name phrases based on the classification of the tokens and the culture of the name.

In another general aspect, parsing a conjoined name includes receiving a conjoined name construct that includes multiple elements. Multiple names indicated by the conjoined name construct are identified. Each of the multiple names includes one or more elements. At least one of the multiple elements of the conjoined name construct is included as an element in each of the multiple names. The one or more elements of at least one name of the multiple names are parsed into element types, and an indication of the element types of the one or more elements of the at least one name is provided.

Implementations may include one or more of the following features. For example, access to multiple parsing algorithms for parsing name elements into one or more types of elements may be enabled. The multiple parsing algorithms may include separate parsing algorithms that respectively correspond to at least one of multiple known cultures. An indication of at least one culture from among the multiple known cultures may be accessed for the at least one name. The indication may reflect at least one culture selected from among the multiple known cultures. One of the multiple parsing algorithms may be selected based on the indication of the culture of the at least one name. Parsing the one or more elements of the at least one name may include parsing the one or more elements using the selected parsing algorithm.

A database providing a statistical indication of a type of an element of the at least one name may be accessed. Parsing also may be based on the statistical indication.

These general and specific aspects may be implemented using a system, a method, or a computer program, or any combination of systems, methods, and computer programs.

Other features will be apparent from the description and drawings, and from the claims.

### DESCRIPTION OF DRAWINGS

FIG. 1 is a block diagram of a system for parsing culturally diverse names.

FIG. 1A is an illustration of a name before and after name phrases of the name are identified.

FIG. 2 shows a first example of records in a database used in classifying name phrases of a name.

FIG. 3 shows a second example of records in a database used in classifying name phrases of a name.

FIG. 3A shows an example of a list used in classifying tokens of a name.

FIG. 4 is a block diagram of a system for checking the validity of a parsed personal name.

FIG. 5 is a flow chart of a first process for parsing culturally diverse names.

FIG. 5A is an illustration of a name before and after name phrases of the name are reordered.

FIG. 6 is an illustration of examples of names before and after parsing.

FIG. 6A is an illustration of a conjoined name construct before and after parsing.

FIG. 7 is an illustration of an interface for parsing names.

FIG. 8 is an illustration of an interface for presenting statistics describing a parsed name.

FIGS. 9 and 10 are further illustrations of interfaces for parsing names.

FIG. 11 is a flow chart of a second process for parsing culturally diverse names.

FIG. 12 is a flow chart of a process for identifying valid parses of names.

### DETAILED DESCRIPTION

Various disclosed implementations include a parser that parses names that are representative of multiple cultures. The parser provides multiple culture-specific parsing algorithms from among which an algorithm is selected based on the culture of an input name to be parsed. Upon receipt of an input name, the parser accesses a name database, referred to as name data object (NDO), that indicates the probability that a particular name phrase of the name is a given name, a surname, a qualifier, or a title. Using culture-specific rules, the parser applies the selected parsing algorithm to parse the name into a title, a given name, a surname, and a qualifier. Then, based on the probabilities from the NDO, the parser calculates a validity score for the name parse, and compares the calculated validity score against a threshold. If the validity score fails to meet the threshold, the parse is deemed invalid, the name phrases of the name are reordered, and the name is parsed and verified again.

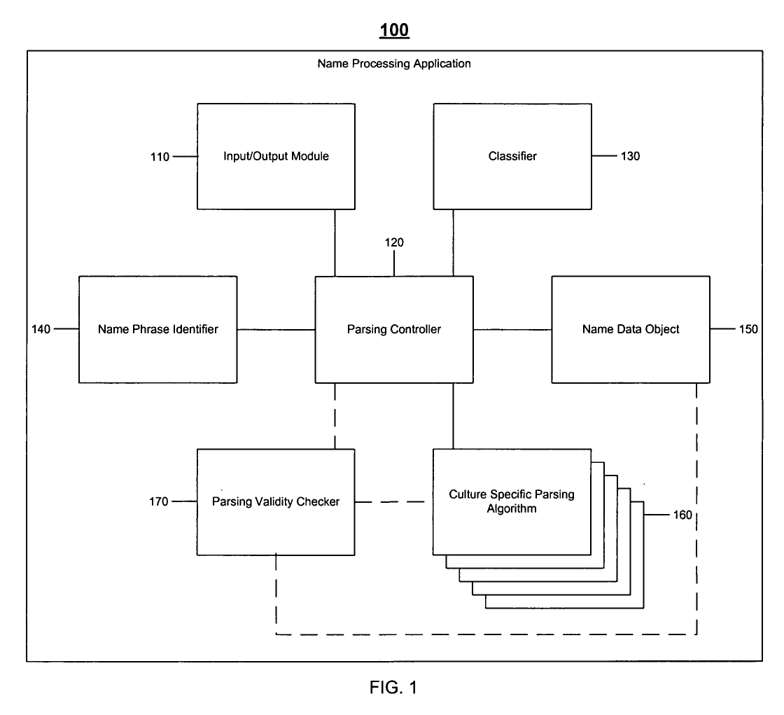

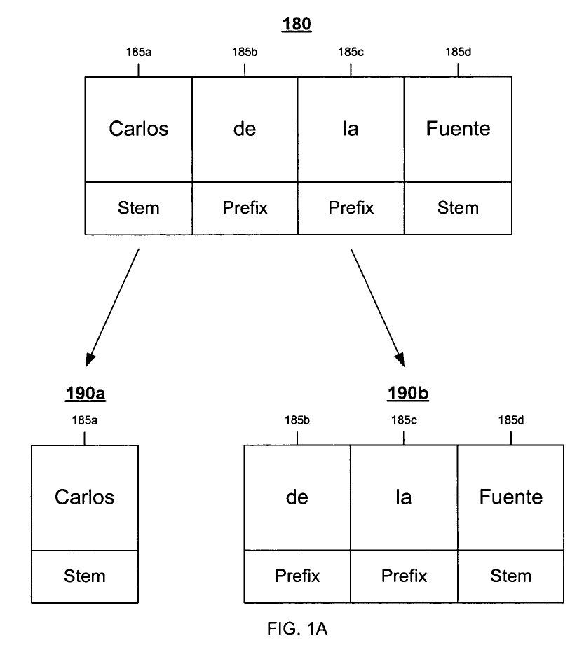

Referring to FIG. 1, a name processing application 100 is used to parse personal names that are representative of multiple cultures. The name processing application 100 includes an input/output module 10 that receives names to be parsed and provides parsed versions of the names. A parsing controller 120 that controls parsing of the names uses a classifier 130, a name phrase identifier 140, an NDO 150, and multiple culture-specific parsing algorithms 160. A parsing validity checker 170 determines whether valid parses of the names have been produced.

The name processing application 100 may be used for multiple purposes. For example, the name processing application may be used to verify that names included in one or more databases have been parsed accurately and/or consistently. The name processing application may be used to correct inaccurately parsed names in the databases and to identify a single parsed version of a name for which multiple parsed versions exist in the databases. Parsing a name consistently may reduce recall errors stemming from using different parses of a name and may help to reduce duplicative records from the database. The name parsing application 100 also may be used to generate alerts of inaccurately parsed names within the database.

The input/output module 110 receives personal names to be parsed and provides parsed versions of the personal names. The input/output module 110 also may receive a specification of one or more parameters that indicate how the personal names are parsed. For example, the input/output module 110 may receive an indication of whether a name is to be reparsed automatically when a previous parse is invalid, or an indication of criteria under which a parse is invalid. In one implementation, the input/output module 110 is a user interface (UI), such as a command line interface or a graphical user interface (GUI), with which the personal names may be specified, and with which the parsed version of the personal names may be presented. Values for the parameters also may be specified with the UI.

In another implementation, the input/output module 110 implements an application programming interface (API) to the name processing application 100. In other words, functions or methods provided by the input/output module 110 may be used by an external application to provide personal names, to receive parsed names, and to provide parameter values. The input/output module 110 may receive the name as text that has been formatted with, for example, the American Standard Code for Information Interchange (ASCII) encoding scheme, the Unicode encoding scheme, or the International Standards Organization (ISO) 8859-1 encoding scheme. A list providing examples of encoding schemes with which the personal names may be formatted may be found at http://www.iana.org/assignments/character-sets.

The parsing controller 120 controls parsing of personal names. More particularly, the parsing controller 120 receives a personal name to be parsed from the input/output module 110. The parsing controller 120 passes the personal name, and information describing the personal name, to the classifier 130, the name phrase identifier 140, the NDO 150, one of the culture-specific parsing algorithms 160, and the parsing validity checker 170, and receives information from these components in the process of parsing the name. The parsing controller 120 then provides the parsed name to the input/output module 110.

The classifier 130 identifies a culture to which a personal name corresponds. More particularly, the classifier 130 receives a personal name to be parsed from the parsing controller 120. The classifier 130 processes the received personal name to identify a culture of the name, and provides an indication of the culture to the parsing controller 120. For example, the classifier 130 may identify the culture based on one or more characteristics of the personal name, or on one or more characteristics of an element of the personal name.

In one implementation, the classifier 130 includes multiple culture-specific classifying algorithms. Each of the algorithms takes a name as an input and produces a score indicating the likelihood that the name is representative of a corresponding culture. An input name is provided to each of the classifying algorithms, and is determined to be representative of the culture corresponding to the algorithm that identifies the greatest likelihood of representation.

Each of the algorithms examines characteristics of the input name, or of elements of the input name, to determine whether the name is representative of the corresponding culture. More particularly, the algorithm identifies characteristics of the input name that are representative of names in the corresponding culture. If such characteristics are identified within the input name, then the algorithm indicates that the name has a high likelihood of being representative of the corresponding culture.

Some of the classifying algorithms identify orthographic characteristics of the input name. For example, such an algorithm may consider the type, position, and order of characters within the input name, or a length of the name, when classifying the input name. Alternatively or additionally, such algorithms may perform an n-gram analysis of the name. In an n-gram analysis of a name, a database that maintains an indication of the likelihood of any sequence of n consecutive characters appearing in a name that is representative of a particular culture is used. The probabilities that sequences of n consecutive characters from the input name are included in the particular culture are accessed from the database and used to determine whether the name is representative of the particular culture.

Other classifying algorithms perform a semantic analysis of the input name. Such an algorithm may identify the meaning of one or more parts of the name. For example, a part of the name may be a word in a language of a particular culture, so the algorithm may determine that the name is representative of the particular culture. As another example, the algorithm may determine that the name is representative of the particular culture when the name includes an affix that is typical of words of a language of the particular culture. Other algorithms may use syllabic, syntactic, or phonological characteristics of the name when determining the likelihoods that the name is representative of corresponding cultures.

In another implementation, the classifier 130 may identify the culture to which the input name corresponds by a process of elimination. For example, one or more of the culture-specific classifying algorithms may indicate that the name is not representative of the corresponding cultures. As a result, the set of cultures to which the input name may correspond is reduced. If a sufficient number of the culture-specific classifying algorithms indicate that the input name is not representative of the corresponding cultures, then a culture to which the name corresponds may thereby be uniquely identified.

An input name may correspond to multiple cultures. For example, a first token of the input name may correspond to a first culture, and a second token of the input name may correspond to a second culture. In one implementation, the classifier 130 may identify, for example, the first culture as a culture of the name if the first token has a stronger correspondence to the first culture than the second token has to the second culture. In such an implementation, the name may be parsed based on a culture to which a portion of the name does not correspond. In another implementation, the classifier 130 may identify both of the first and second cultures as the culture of the name. In such an implementation, the name may be parsed individually based on each of the first and second cultures. One of the resulting parses may be selected as the parsed version of the name, or the resulting parses may be combined into the parsed version of the name. Alternatively or additionally, the name may be parsed simultaneously based on both the first and second cultures.

Various implementations for classifying a name are described in U.S. application Ser. No. 09/275,766, titled “System and Method for Adaptive Multi-Cultural Searching and Matching of Personal Names,” and filed on Mar. 25, 1999. U.S. application Ser. No. 09/275,766 is hereby incorporated by reference in its entirety for all purposes.

The name phrase identifier 140 identifies one or more name phrases included in a personal name. Each of the name phrases may include one or more tokens. For example, the name phrase includes a stem to which zero or more prefixes or suffixes have been added. The stem of the name phrase is the portion of the name phrase that is not a prefix or a suffix of the name phrase. The name phrase identifier 140 may consult a culture-specific list of possible prefixes and suffixes, such as is maintained by the NDO 150, when identifying the name phrases. For example, using the NDO 150, the name phrase identifier 140 may classify each token of the name as a prefix, a suffix, or a stem in names of a particular culture of the name. A token may be classified as a stem as a result of not being included in the list of prefixes and suffixes for the particular culture, or as a result of being included in a list of name phrases included in names of the particular culture, such as is maintained by the NDO 150. Consequently, the classification of the tokens may depend on the particular culture of the name.

The classification and the order of the tokens may indicate the name phrases of the name. In general, a name phrase includes a stem, the tokens that immediately precede the stem that are prefixes, and the tokens that immediately follow the stem that are suffixes. For example, referring to FIG. 1A, a name 180, “Carlos de la Fuente” includes four tokens 185a-185d. The tokens 185a and 185d may be classified as stems, and the tokens 185b and 185c may be classified as prefixes. Because the name 180 includes two stem tokens 185a and 185d, the name 180 includes two name phrases 190a and 190b. The name phrase 190a includes the token 185a, which is not preceded by any prefix tokens or followed by any suffix tokens. The name phrase 190b includes the token 185d, which is preceded by the prefix tokens 185b and 185c. In some implementations, a prefix that follows the stem may be part of the name phrase as long as a suffix appears between the prefix and the next stem.

Therefore, the grouping of the tokens of the name into name phrases may depend on lexical and syntactic characteristics of the name. The lexical characteristics include the classifications of the tokens as prefixes, suffixes, and stems, and the syntactic characteristics include the order in which the tokens appear in the name. Furthermore, the grouping may depend on the culture of the tokens. For example, a prefix may be grouped with a subsequent stem only if the prefix and the stem correspond to the same culture, or only if name phrases of names of a culture of the stem typically include prefixes.

Alternatively, or additionally, the name phrase identifier 140 may consult the list of name phrases when identifying the name phrases. For example, the name phrase identifier 140 may look up a group of one or more consecutive tokens from the name in the list to determine whether the group represents a name phrase. After the group has been identified as a name phrase, name phrases that include the remaining tokens in the name are identified. In this manner, the set of possible name phrases may be reduced with each name phrase that is identified, until a complete set of valid name phrases included in the name have been identified.

In one implementation, the name phrase identifier 140 identifies the name phrases without reference to a culture of the name that was identified by the classifier 130. In another implementation, the name phrase identifier 140 may use culture-specific information when identifying the name phrases. The name phrase identifier 140 may identify the name phrases such that statistics describing the name phrases may be identified from the NDO 150.

Identifying name phrases of names and processing the names based on the name phrases may be advantageous over processing the names based on tokens of the names. For example, processing names based on name phrases may be particularly useful when processing non-English names that have been transliterated from a non-Roman alphabet. Multiple transliteration schemes may be available to transliterate the names from the non-Roman alphabet to the Roman alphabet. When transliterating a name, the transliteration schemes may use different numbers of tokens to represent a particular continuous portion of the name, such as, for example, a surname. Therefore, different transliterations of the name may include different numbers of tokens. However, the different transliterations typically include the same number of name phrases for the name. More particularly, the different transliterations typically include a single name phrase for the particular portion (for example, the surname) of the name. Therefore, processing of the name based on the name phrases may reduce the effect of inconsistent separation of portions of the name into tokens. In other words, using the name phrases enables the processing of the name to withstand incorrectly, or inconsistently, placed boundaries between tokens (for example, “de la Tour” versus “Delatour”). As another example, particular tokens of the names may have more meaning or significance to the name when they are combined with one or more adjacent tokens. For example, in Arabic names, the prefix “al” may be more meaningful when combined with an adjacent stem token, as many Arabic surnames include the prefix “al.”

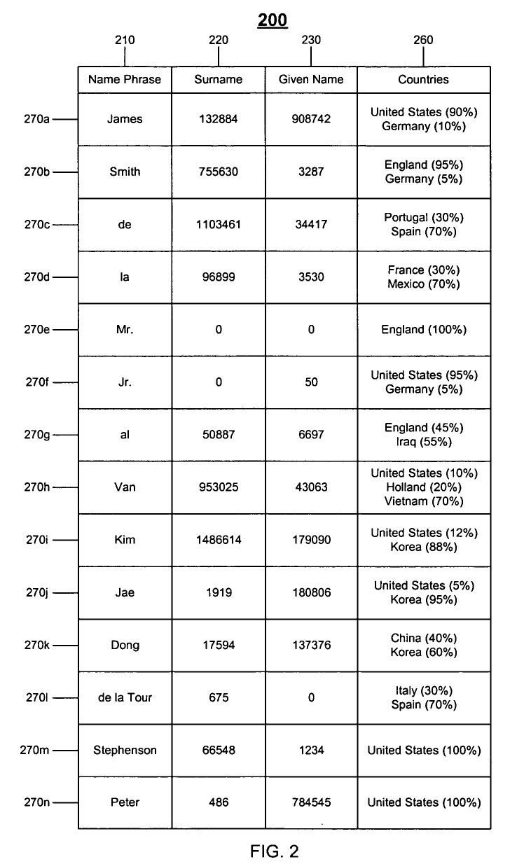

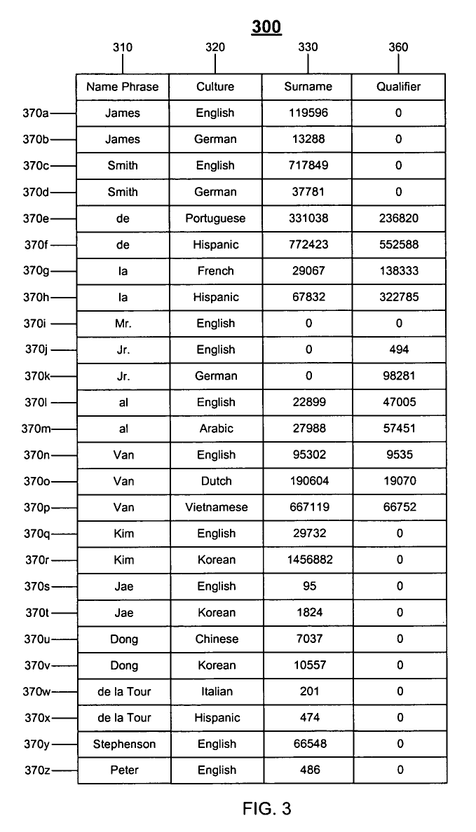

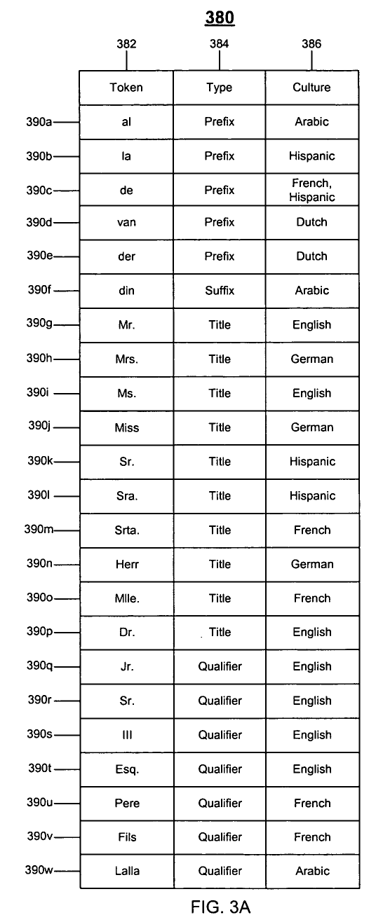

The NDO 150 is a database of name phrases and relative frequencies with which the name phrases appear in personal names from a variety of cultures. More particularly, the NDO 150 includes the name phrases that are included in a large set of culturally-diverse personal names. For each name phrase (see, for example, FIGS. 2 and 3), the NDO 150 indicates the number of times the name phrase is included in the set as a given name or as a surname. In addition, the NDO 150 includes a list of name phrases that are titles, and a list of name phrases that are qualifiers. Therefore, the NDO 150 indicates the probability that a name phrase is included in a given name, a surname, a qualifier, or a title of a name.

The given name, the surname, the qualifier, and the title represent four possible types of a name phrase. A surname typically indicates an association (e.g., family, clan, tribe, ethnic group, religion, profession, location, or lineage.). A given name designates an individual. A title typically identifies a position, a social status, or a gender. Examples of titles include “Mr.,” “Mrs.,” “Ms.,” “Dr.,” “Sr.,” “Sra.,” “Mlle.,”and “Herr.,” Qualifiers modify portions of a given name or a surname, or further describe or identify the individual corresponding to the personal name. Examples of qualifiers include “Jr.,” “Sr.,” “III,” and “Esq.”

In addition, the NDO 150 includes, for each name phrase, an indication of at least one country or culture having names that include the name phrase, particularly those name phrases that are included in the set as a given name or as a surname. For each indicated country or culture, the NDO 150 also includes an indication of the number of names, from among the set of names, that include the name phrase and that are representative of the country or culture. In one implementation, the NDO 150 includes information describing name phrases from approximately one billion culturally-diverse personal names.

Referring to FIGS. 2 and 3, part of the NDO 150 may be organized as a table. For example, the NDO 150 includes a statistics table 200 having columns 210-260 and rows 270a-270n. A name phrase column 210 contains one name phrase per row. A surname column 220 includes counts of the names from the set (described earlier) that include the name phrases as surnames. For example, 132,884 names from the set include the name phrase “James” as a surname, as is indicated by the number at the intersection of row 270a and the surname column 220. Similarly, a given name column 230 includes counts of the names from the set that include the name phrases as given names. For example, 179,090 names from the set include the name phrase “Kim” as a given name, as is indicated by the number at the intersection of row 270i and the given name column 230.

For each of the rows 270a-270n, the country column 260 indicates one or more countries or cultures with names that include the corresponding name phrase. For example, names from the United States, Holland, and Vietnam include the name phrase “Van,” as is indicated by the information at the intersection of row 270h and the country column 260. The country column 260 also includes an indication of a relative proportion of the names that include the name phrase among the one or more countries or cultures. For example, 70% of the names that include the name phrase “Van” are from Vietnam, 20% are from Holland, and 10% are from the United States, as is indicated by the information at the intersection of row 270h and the country column 260.

FIG. 3 includes a statistics table 300 that is similar to the statistics table 200 and includes columns 310-360 and rows 370a-370z. A name phrase column 310, a surname column 330, and a given name column 340 are similar to corresponding columns 210-230 of the statistics table 200. In addition, the statistics table 300 indicates the number of times a name phrase appears in names from each of one or more countries or cultures as each of the possible types.

A culture column 320 indicates at least one culture with names that include the name phrases. For example, Arabic names include the name phrase “al,” as is indicated by the culture listed at the intersection of row 370m and the culture column 320. A name phrase may be represented in multiple rows of the statistics table 300. For example, the name phrase “Jae” is represented by rows 370s and 370t in the statistics table 300. A name phrase corresponds to multiple rows when the name phrase is included in names from multiple cultures, and the statistics table 300 includes a separate row for the name phrase for each of the multiple cultures. For any such row, columns 330 and 340 indicate the number of names, from the set of names, that correspond to the particular culture and that include the particular name phrase as a surname or a given name, respectively. For example, the row 270i and the column 260 of the statistics table 200 indicate that the name phrase “Kim” may appear in English and Korean names. Consequently, the statistics table 300 includes the row 370q to describe English names that include “Kim” and the row 370r to describe Korean names that include “Kim.” For example, the row 370q indicates that 175,508 English names from the set of names include “Kim” as a given name, while the row 370r indicates that 1,456,882 Korean names from the set of names include “Kim” as a surname. Therefore, most of the names in which “Kim” appears as a given name are English names, even though most of the names in which “Kim” appears are Korean names.

Referring also to FIG. 3A, the NDO 150 also includes a token table 380 that identifies tokens that are prefixes to stems of name phrases, tokens that are suffixes to stems of name phrases, tokens that are stems of title name phrases, and tokens that are stems of qualifier name phrases. The tokens included in the tokens table 380 may be included in names from the set of names. The token table 380 includes columns 382-386 and rows 390a-390w. A token column 382 contains one token per row. A type column 384 indicates the types of the tokens. For example, the token “de” is a prefix, as indicated row 390c and the type column 384. Similarly, a culture column 386 indicates one or more cultures of names from the set of names that include the tokens. For example, the token “Herr” typically is included in German names, as indicated by the row 390n and the column 386.

The token table 380 enables the classification of tokens of a name as, for example, a prefix, a suffix, or a stem of a name phrase of a name, based on a culture of the name. For example, the row 390f, the column 384, and the column 386 indicate that the token “din” is a suffix in Arabic names. As another example a token that is not included the token table 380 as a prefix or a suffix in the culture of the name may be assumed to be a stem of a name phrase, by a process of elimination.

The token table 380 also enables the classification of tokens as stem tokens of either a title or a qualifier in names of a particular culture. For example, the row 390q, the column 384, and the column 386 indicate that the token “Jr.” is a stem token of a qualifier in English names. As another example, a token that is not included in the token table 380 as a stem of either a title or a qualifier of names of the particular culture may be assumed to be a stem of either a given name or a surname, by a process of elimination. When a token is not included in the token table 380 as a stem of a title or a qualifier, the token may be included in one of the statistics tables 200 or 300, which may indicate whether the token is a stem of a given name or a surname.

The token table 380 may be used, for example, by the name phrase identifier 140 when identifying name phrases of a name. In addition, the token table 380 may be used when identifying statistics for a name phrase from one of the statistics tables 200 or 300. For example, if a name phrase is not included in one of the statistics tables 200 or 300, then the token table 380 may be used to identify a stem of the name phrase that may be included in one of the statistics tables 200 or 300. The statistics for the stem may be used as the statistics for the name phrase.

The numbers included in the statistics table 200 and the statistics table 300 enable the determination of the relative frequencies of appearance for different name phrases. For example, the rows 270b and 270k indicate that names (from the set of names) include the name phrase “Smith” more often than the name phrase “Dong.” In addition, the statistics tables 200 and 300 enable the classification of a name phrase as a given name or a surname. For example, the row 270c indicates that the name phrase “Van” most likely is a surname, because “Van” appears in the set of names more often as a surname than as a given name. Furthermore, the token table 380 enables the classification of a name phrase a title or a qualifier. For example, the row 390g, the column 384, and the column 386 of the token table 380 indicate that the name phrase “Mr.” is a title in English names.

A token may appear in both the token table 380 and one of the statistics tables 200 and 300. For example, a token may represent a prefix or a suffix in names of a first culture, and a given name or a surname in a second culture. For example, the token table 380 indicates that the token “van” is a prefix in Dutch names, and the statistics table 300 indicates that the token “Van” is a surname in Vietnamese names. In such a case, the token may be uniquely classified based on the culture of a name that includes the token using one of the token table 380 or the statistics tables 200 and 300. Alternatively, the token may represent a prefix or suffix in some names of a particular culture, and a given name or a surname in other names of the particular culture. In such a case, classification of the token is based on the token table 380, and not one of the statistics tables 200 or 300.

Turning now to the algorithms 160, the parsing controller 120 passes to one of the algorithms 160 a name to be parsed. The algorithm 160 that receives the name is an algorithm that parses names from the culture that was determined by the classifier 130. The parsing controller 120 also may provide the algorithm 160 with an indication of the name phrases that are included in the name, and statistics describing the name phrases that have been retrieved from the NDO 150. Using the information received from the parsing controller 120, the algorithm 160 classifies the name phrases of the name as one of the possible types of name phrases. In other words, the algorithm 160 classifies each of the name phrases as being included in a title, a given name, a surname, and a qualifier of the name. Consequently, the algorithm 160 may indicate that multiple name phrases have the same type within the name. The multiple name phrases of the same type may be grouped together. For example, if the algorithm 160 indicates that two name phrases are given names, the two name phrases may be grouped to form a single given name for the parsed name. In one implementation, the order in which the multiple name phrases are grouped is the order in which the multiple name phrases appear in the original name. Each of the algorithms 160 may use conventional parsing techniques to parse names of corresponding cultures.

Each of the culture-specific parsing algorithms 160 parses names that are representative of one or more cultures. For example, algorithms 160 may include an algorithm for parsing Chinese names, an algorithm for parsing Korean names, an algorithm for parsing Japanese names, an algorithm for parsing Spanish names, an algorithm for parsing Arabic names, and an algorithm for parsing English names. Alternatively or additionally, the algorithms 160 may include, for example, an algorithm that parses Asian names, instead of dedicated algorithms for each type of Asian name. In some implementations, the culture-specific parsing algorithms 160 may include a generic parsing algorithm that is configured to parse names that are representative of any culture. The generic parsing algorithm may be used, for example, when a culture-specific parsing algorithm for a name is not identified.

The algorithm for parsing names of a particular culture uses characteristics of names of the particular culture to determine how to parse the name. For example, an algorithm for a particular culture may access indications of prefixes, suffixes, titles, and qualifiers that are specific to the particular culture from the NDO 150. The culture-specific prefixes, suffixes, titles, and qualifiers may be used to group tokens of the names into name phrases, and to identify which of the name phrases represent titles and qualifiers for the name.

As another example, an algorithm for parsing Asian names may use the convention that a surname precedes a given name to identify the leftmost name phrase as the surname and the rightmost name phrase as the given name. However, the algorithm might do so only when the statistics received from the NDO 150 indicate that the leftmost name phrase is a surname and that the rightmost name phrase is a given name. For example, if the statistics indicate that the leftmost name phrase is a given name and that the rightmost name phrase is a surname, then the algorithm may conclude the same, even though such a conclusion violates the conventional structure of Asian names. Additionally, when the culture-specific algorithm 160 examines the statistics for a name phrase, the algorithm 160 may consult the culture-specific statistics (for example, from the statistics table 200) or the combined statistics (for example, from the statistics table 300).

As another example, an algorithm for parsing Arabic names may use knowledge that many surnames are preceded by the prefix “al” to determine that, in a name that includes that prefix, the prefix forms a name phrase with a token that immediately follows the prefix. Furthermore, the algorithm may determine that the name phrase is likely to be a surname because the name phrase includes the prefix “al.” However, the algorithm might only do so if the statistics received from the NDO 150 indicate that the token following the prefix typically is a surname.

The parsing validity checker 170 determines whether a parse of a name identified by one of the algorithms 160 represents a valid parse of the name. In one implementation, the parsing validity checker 170 receives the parsed name from the parsing controller 120 after the parsing controller 120 receives the parsed name from one of the algorithms 160. In another implementation, the parsing validity checker 170 receives the parsed name directly from the algorithms 160. In one implementation, each of the algorithms 160 includes a parsing validity checker 170. In such an implementation, the parsing validity checker 170 corresponding to one of the algorithms 160 determines whether parsed names produced by the algorithm are valid.

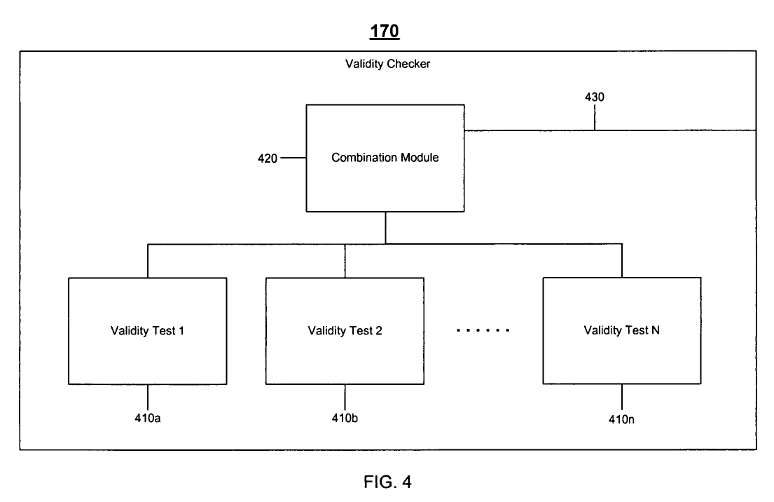

Referring to FIG. 4, one implementation of the parsing validity checker 170 includes multiple validity tests 410a-410n. Each of the validity tests 410a-410n examines characteristics of at least a portion of a parsed name to aid in a determination of whether the parsed name is valid. A combination module 420 combines the results of the validity tests 410a-410n into an overall indication of the validity of the parsed name. The indication of the validity of the parsed name is sent from the parsing validity checker 170 over a communications interface 430 to other components of the application 100.

In one implementation, the validity tests 410a-410n measure the conformity of the parsed name to a set of criteria. For example, the validity tests may measure the conformity of the parsed name to other names of the same culture as the parsed names, or to other names that include the same name phrases as the parsed name. Each of the validity tests 410a-410n assigns a score to at least a portion of the parsed name based on the characteristics of the parsed name.

For example, one or more of the tests 410a-410n may identify a dominance factor for one or more of the name phrases included in the parsed name. The dominance factor indicates the ratio of (i) the names in the set of names reflected in the NDO 150 that include the name phrase as a particular type to (ii) the names in the set that include the name phrase as any of the possible types. Dominance factors typically are calculated for name phrases that have been classified as given names or surnames in the parsed name, and the dominance factor of a name phrase depends on whether the name phrase has been classified as a given name or a surname. If the parsed name includes the name phrase as a given name, then the dominance factor for the name phrase indicates the likelihood that the name phrase is a given name. In such a case, the dominance factor is the ratio between (i) the number of names from the set of names that include the name phrase as a given name and (ii) the number of names from the set of names that include the name phrase as any of the possible types. Similarly, when the parsed name includes the name phrase as a surname, the dominance factor indicates the likelihood that the name phrase is a surname. Dominance factors may not be calculated for name phrases that have been classified as titles or qualifiers because such name phrases typically are not incorrectly classified. In other words, the only name phrases that are classified as titles are name phrases that the NDO 150 indicates are titles, and the only name phrases that are classified as qualifiers are name phrases that the NDO 150 indicates are qualifiers. However, name phrases that the NDO indicates are titles or qualifiers also may be classified as given names or surnames.

One or more of the validity tests 410a-410n may assign dominance factors to special name phrases. Special name phrases include name phrases that include an initial, name phrases that are not included in the NDO 150, and name phrases that include a title or a qualifier. For example, a name phrase that includes an initial may be passed to a particular one of the tests 410a-410n. Name phrases that include an initial typically are classified as given names. Consequently, the particular test may assign a dominance factor to the name phrase to indicate that the name phrase typically appears as a given name. In one implementation, the test may assign the name phrase a high dominance factor when the name phrase has been classified as a given name in the parsed name, and the test may assign the name phrase a low dominance factor when the name phrase has been classified as a surname in the parsed name. In one implementation, the high dominance factor is 0.8, or 80%, and the low dominance factor is 0.2, or 20%.

Another one of the tests 410a-410n may indicate that a name phrase that is not included in the NDO 150 is not to be assigned a dominance factor and is not to be considered when determining the overall validity score of the parsed name. Alternatively or additionally, the test may indicate that the name phrase is not to be considered when a portion of the name phrase is not included in the NDO 150. For example, the test may indicate that the name phrase is not to be considered when a stem of the name phrase is not included in the NDO 150.

Another one of the tests 410a-410n may indicate that a name phrase with a stem that typically is a title or a qualifier be assigned a dominance factor of 0.1, or 10%, regardless of whether the name phrase has been classified as a given name or as a surname in the parsed name. The NDO 150 may indicate whether the stem of the name phrase is a title or a qualifier.

Others of the tests 410a-410n may process the parsed name as a whole to identify a validity score for the parsed name. For example, one of the tests 410a-410n may determine whether or not the parsed name includes at least one given name and at least one a surname. If not, then the test may assign a validity score of 0.5, or 50%, to the parsed name, which typically indicates that the parsed name is invalid.

Another one of the tests 410a-410n may determine whether or not the name phrases included in the parsed name as given names or surnames are included in the NDO 150. If none of the name phrases are included in the NDO 150, then the test may assign a validity score of 0.5, or 50%, to the parsed name.

Another one of the tests 410a-410n may base the validity score on whether an order in which the name phrases appear in the parsed name is an order in which the name phrases typically appear, as indicated by information describing the name phrases from the NDO 150, and by characteristics of names of a culture of the parsed name. The test may assign a high validity score when the order of the name phrases in the parsed name is an order in which the name phrases typically appear, and the test may assign a low validity score otherwise.

Another one of the tests 410a-410n may determine whether the name phrases are spelled correctly. For example, the test may determine whether a misspelled name phrase was included as a given name when the name phrase, when spelled correctly, typically is included as a surname. If the misspelled name phrase is incorrectly classified within the parsed name, the test may assign a low validity score to the parsed name. In some implementations, the test also may correct the spelling of the name phrase.

The combination module 420 mediates the operation of the parsing validity checker 170. In one implementation, the combination module 420 provides at least a portion of the parsed name, such as a name phrase, to each of the validity tests 410a-410n and receives a score from each of the validity tests 410a-410n. The combination module 420 combines the scores received from the tests 410a-410n into an overall validity score for the parsed name. For example, the combination module 420 may normalize and average, or otherwise combine, the scores to identify the validity score. In one implementation, the combination module 420 may receive dominance factors for some of the name phrases of the parsed name from one or more of the tests 410a-410n, and the combination module 420 may average the dominance factors to identify the validity score for the parsed name as a whole. Alternatively, for each dominance factor that is less than 0.5, the combination module may subtract a fixed amount from a maximum allowable overall validity score, and the remainder of the maximum allowable validity score may represent the validity score for the parsed name as a whole. Alternatively, the combination module may apply a logarithmic function to each of the dominance factors (e.g., raise 10 to the power of the difference of one and the dominance factor), and then may average the resulting values to identify the validity score for the parsed name.

In another implementation, the combination module 420 may receive a validity score for the parsed name from each of the tests 410a-410n and may average the received validity scores to identify the overall validity score for the parsed name. In one implementation, the validity score is a number between 0 and 1, or a corresponding percentage between 0% and 100%. The validity score also may be referred to as a confidence in the parsed name.

The validity score is passed from the validity checker to the parsing controller 120 over the communications interface 430. In addition, the parsed name, and information describing the parsed name, is received over the communications interface 430. The parsing controller 120 may determine whether the parsed name is valid based on the validity score that is received from the parsing validity checker 170. In one implementation, the controller 120 may determine that the parsed name is valid when the validity score is greater than a threshold value. If the parsed name is invalid, then the parsing controller 120 may reorder (described later) the name phrases of the name and parse the name again.

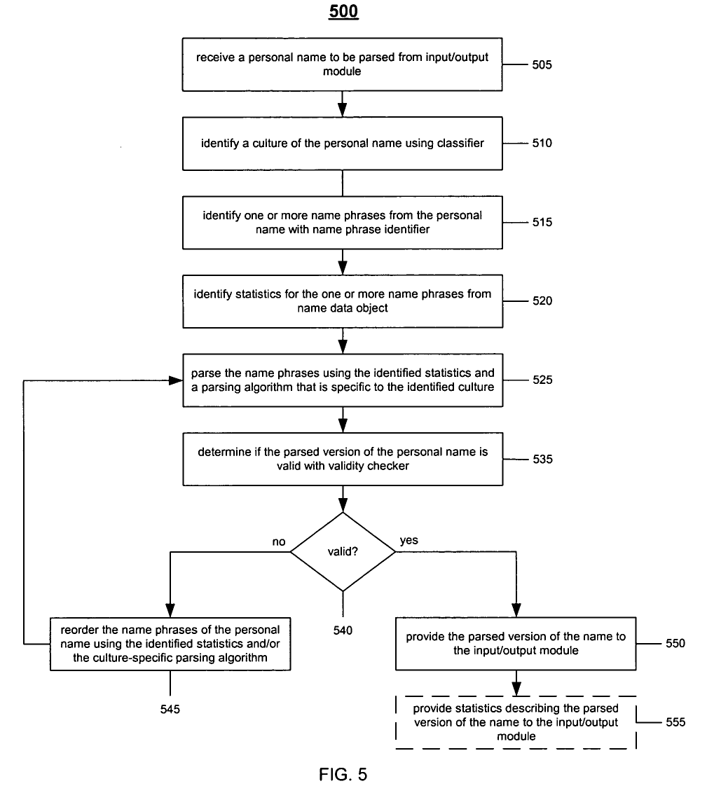

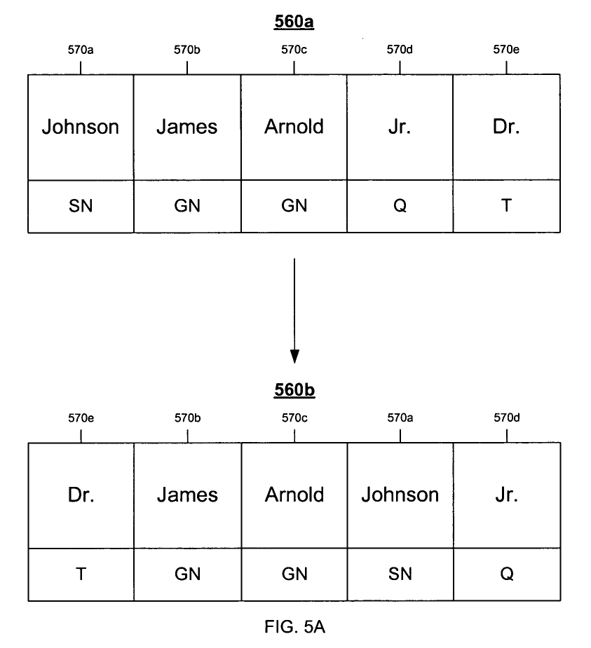

Referring to FIG. 5, a process 500 is used to parse a personal name that is representative of one of multiple supported cultures. The process may be executed by a name processing application, such as the name processing application 100. More particularly, the process may be executed by a parsing controller of the name processing application, such as the parsing controller 120.

The controller receives a personal name to be parsed from an input/output module of the name processing application, such as the input/output module 110 (505). In implementations where the input/output module is a UI for the name processing application, the input/output module receives a specification of the name from a user of the UI. In implementations where the input/output module implements an API to the name processing application, the input/output module receives the name through an invocation of a method or function provided by the API. For example, a “parse” method provided by the API may be called with the name as an argument to the method. The input/output module passes the received personal name to the controller for further processing.

The controller identifies a culture of the personal name using a classifier, such as the classifier 130 (510). More particularly, the controller passes the name to the classifier, and the classifier identifies and returns an indication of a culture of the name. The classifier may determine one or more characteristics of the personal name, and may identify the culture based on the determined characteristics.

The controller then identifies one or more name phrases from the personal name with a name phrase identifier, such as the name phrase identifier 140 (515). More particularly, the controller passes the name to the name phrase identifier, and the name phrase identifier identifies and returns the name phrases. In one implementation, the name phrase identifier classifies each token of the name as a prefix, a suffix, or a stem, and uses the classification to identify the name phrases. In another implementation, the name phrase identifier consults a list of name phrases, such as is maintained by the NDO 150, when identifying the name phrases. In addition to the name, the controller also may provide an indication of the culture of the name to the name phrase identifier, and the name phrase identifier may use the indication of the culture when identifying the name phrases.

The controller identifies statistics describing the name phrases of the name from an NDO of the name processing application, such as the NDO 150 (520). More particularly, for each name phrase, the controller accesses indications of the number of names, from a set of culturally-diverse names, that include the name phrase as each of the possible types. The controller also may access indications of countries or cultures with names that include the name phrases, as well as numbers of names from each of the countries or cultures that include the name phrases, from the NDO. In implementations where the name phrase identifier accesses the statistics from the NDO when identifying the name phrases, the name phrase identifier may provide the statistics to the controller.

The controller parses the name phrases using the identified statistics and a parsing algorithm that is specific to the identified culture, such as one of the parsing algorithms 160 (525). More particularly, the parsing algorithm may be identified from among several potential parsing algorithms based on non-equivalent matching. For example, if the identified culture of the name is the Korean culture, the parsing algorithm may be specific to multiple Asian cultures, including the Korean culture. The controller passes the name phrases and the identified statistics to the parsing algorithm. The controller also may provide, for example, an indication of the order in which the name phrases appear in the personal name, and other syntactic information describing the personal name, to the parsing algorithm. The parsing algorithm separates the name phrases into the possible types using the identified statistics and characteristics of names of the identified culture. The parsing algorithm provides a parsed version of the personal name to the controller, and the controller receives the parsed version of the name.

The controller determines whether the parsed version of the name is valid using a parsing validity checker, such as the parsing validity checker 170 of FIGS. 1 and 4 (535). The controller passes the parsed version of the name to the validity checker. The controller also may provide other information describing the personal name, such as the statistics that were identified from the NDO, to the validity checker. The validity checker performs one or more tests that examine characteristics of the parsed version of the name. The results of the tests are combined into an overall indication of the validity of the parsed name, such as a validity score. The controller receives the indication of the validity of the parsed name from the validity checker.

The controller determines whether the parsed version of the name is valid (540). More particularly, the controller determines whether the indication of the validity of the parsed name indicates that the parsed name is valid. For example, if the indication of the validity of the parsed name is a validity score, the controller may determine that the parsed version of the name is valid when the validity score exceeds a threshold value. The threshold value may be user-specified and may be received when the name is received. In one implementation, the threshold value is 0.65, or 65%.

If the parsed version of the name is not valid, then the controller reorders the name phrases of the name (545). The name phrases of the name may be reordered such that the name phrases that are titles appear first, followed in order by (i) the name phrases that are given names, (ii) the name phrases that are surnames, and (iii) the name phrases that are qualifiers. The name phrases may be classified as one of the possible types based on the identified statistics. For example, a name phrase may be classified as a given name when the identified statistics indicate that the name phrase typically appears as a given name either across all cultures or for a particular culture. The identified statistics may indicate that a name phrase typically appears as a given name when, for example, at least half of the names that include the name phrase include the name phrase as part of a given name.

A name may include multiple name phrases of the same type. In one implementation, when multiple name phrases have the same type, the relative order of the multiple name phrases within the reordered name is not changed.

Referring to FIG. 5A, parsing a name 560a, “Johnson James Arnold Jr. Dr.” with five name phrases 570a-570e initially may lead to an invalid parse. The statistics identified for the name phrases 570a-570e may indicate (as shown in FIG. 5A, below each name phrase) that the name phrase 570a is a surname (SN), the name phrase 570b is a given name (GN), the name phrase 570c is a given name, the name phrase 570d is a qualifier (Q), and the name phrase 570e is a title (T). In such a case, the name phrases of the name 560a, which originally appeared in the order “Johnson James Arnold Jr. Dr.,” may be reordered to appear in the order “Dr. James Arnold Johnson Jr.,” as indicated in the reordered name 560b. In the reordered name 560b, titles appear before given names, which appear before surnames, which occur before qualifiers. In addition, the relative order of name phrases of the same type is maintained. For example, the relative order in the name 560b of the name phrases 570b and 570c, which are both given names, is unchanged from the name 560a.

When a name includes multiple name phrases that are given names or surnames, but does not include both a given name and a surname, the name is assumed to be complete. In other words, it is assumed that the name should include at least one name phrase that is a given name and at least one name phrase that is a surname. Therefore, the name phrases may be reordered such that at least one name phrase is classified as a given name, and such that at least one name phrase is classified as a surname. Doing so may increase the likelihood that a valid parse of the name may be identified.

For example, when the identified statistics indicate that all of the multiple name phrases are surnames, one of the multiple name phrases is classified as a given name. Dominance factors are calculated for the multiple name phrases. The dominance factors indicate the likelihood that the multiple name phrases are surnames. The name phrase with the lowest dominance factor has the greatest likelihood of being a given name, and that name phrase is included in the reordered name as a given name. If more than one of the multiple name phrases share the lowest dominance factor, then the name phrase with the lowest dominance factor that appears first in the personal name is classified as a given name. Similar classifications are made when the identified statistics indicate that all of the multiple name phrases are given names.

For example, the statistics table 200 indicates that the three name phrases of the name “Smith Kim Stephenson” are surnames. Moreover, the statistics table 200 indicates that the dominance factor of “Smith” is 0.996, that the dominance factor of “Kim” is 0.892, and that the dominance factor of “Stephenson” is 0.982. Because “Kim” has the lowest dominance factor, to some extent because “Kim” appears as a given name more often than “Smith” or “Stephenson” appear as given names, “Kim” is classified as a given name. Because given names are placed before surnames in the reordered name, and because the relative order of the name phrases is otherwise maintained, the reordered name is “Kim Smith Stephenson.”

In another implementation, the name phrases may be ordered based on corresponding dominance factors. For example, name phrases may be included in order of increasing dominance factors. In such a case, the reordered name becomes “Kim Stephenson Smith.”

Because “Kim” appears first in the reordered name, “Kim” is classified as a given name. As another example, a name may include three name phrases, and all three name phrases may be given names. In such a case, one of the given names is classified as a surname, similarly to how a surname was classified as a given name in the above example.

In another implementation, the name phrases may be reordered arbitrarily. In other words, the name phrases may be placed in an order in which the name phrases have not previously been placed for parsing. Such reordering of the name phrases does not require classification of the name phrases as one of the possible types.

In another implementation, only a subset of the name phrases may be reordered, based on a determined validity of a parsed version of the name, or on statistics gathered in the parsing process. For example, the statistics may indicate that two name phrases appear to be reversed. In such a case, the positions of the two name phrases may be reversed, and the other name phrases may remain in place.

After the name phrases of the personal name have been reordered, the name phrases and the identified statistics are parsed again using the culture-specific parsing algorithm (525). A new parsed version of the personal name that is identified by the parsing algorithm typically classifies the name phrases of the name into the possible types that were indicated by the reordered name phrases. For example, the name phrases that appear first typically are classified as titles, the next name phrases as given names, the next name phrases as surnames, and the next name phrases as qualifiers. Rather than parsing the name phrases again to classify the name phrases, the name phrases may be classified directly into the possible types that were indicated by the reordered name phrases.

The controller may determine whether the new version is valid (535, 540). If the new version also is not valid, then the name phrases may be reordered again (545), and the name may be parsed again with the culture-specific parsing algorithm (525). In this manner, a name may be repeatedly parsed until a valid parse of the name is identified. However, in typical implementations, parsing the name more than twice does not identify a parsed version of the name that is different from the parsed version of the name identified by the second parse of the name.

If a subsequent parsed version of the name does not differ from a previous parsed version of the name, then the name might not be parsed again, and a previously identified parsed version of the name that is the most valid may be identified as an appropriate parse of the name. Furthermore, if the validity of a subsequent parsed version does not improve over the validity of a previous parsed version, then the name might not be parsed again, and a previously identified parsed version of the name that is the most valid may be identified as an appropriate parse of the name. For example, if a validity score of the subsequent parsed version is not greater than the validity score of the previous parsed version, then the name might not be parsed again. In such a case, a technically invalid parsed version of the name may be produced. In typical implementations, the previously identified parsed version of the name that is most valid is the first parsed version of the name.

If the parsed version of the name is valid (545), then the controller provides the parsed version of the name to the input/output module (550). More particularly, the controller provides the input/output module with indications of the name phrases of the name that are included in the title, the given name, the surname, and the qualifier in the parsed version of the name. In some implementations, the controller may provide only a portion of the parsed version of the name to the input/output module. For example, the controller may provide only the given name and the surname of the parsed name to the input/output module. In some implementations, the controller may provide the parsed version of the name to the input/output module when the parsed version of the name is not valid. The controller may do so, for example, if a name is not to be reparsed automatically in response to an invalid parse. If the name has been parsed multiple times, the controller may provide the multiple parsed versions of the name to the input/output module. A recipient of the multiple parsed versions from the input/output module may select one of the multiple parsed versions for use.

In addition, the controller may provide statistics describing the parsed version of the name to the input/output module (555). For example, the controller may provide the statistics retrieved from the NDO for each of the name phrases included in the parsed version of the name. As another example, the controller may provide an indication of the validity of the parsed version of the name. In implementations where the input/output module is a UI for the name processing application, the input/output module may present the parsed version of the name and the statistics with the UI. In implementations where the input/output module implements an API to the name processing application, the input/output module may provide the parsed version of the name and the statistics as returned values from the method or function that was invoked to indicate that the name should be parsed.

As an example, the process 500 may be used to parse the name “Kim Jae Dong.” The controller receives the name from the input/output module (505). The controller uses the classifier to identify a culture of the name, which is Korean in this case (510). The controller uses the name phrase identifier to determine that the name includes three name phrases, “Kim,” “Jae,” and “Dong” (515). The controller retrieves statistics for the three name phrases from the NDO (520). The statistics may be culture-specific statistics (for example, from the statistics table 200) or combined statistics (for example, from the statistics table 300). For example, as indicated in row 370r of the statistics table 300, the name phrase “Kim” occurs as a title in 0 Korean names, as a given name in 161,181 Korean names, as a surname in 1,337,953 Korean names, and as a qualifier in 0 Korean names. Therefore, as a Korean name, “Kim” is typically a surname. As indicated in row 370t, the name phrase “Jae” occurs as a title in 0 Korean names, as a given name in 171,766 Korean names, as a surname in 1824 Korean names, and as a qualifier in 0 Korean names. Therefore, as a Korean name, “Jae” is typically a given name. As indicated in row 370v, the name phrase “Dong” occurs as a title in 0 Korean names, as a given name in 82,426 Korean names, as a surname in 10,557 Korean names, and as a qualifier in 0 Korean names. Therefore, as a Korean name, “Dong” is typically a given name.

The controller parses the name phrases using the identified statistics and a parsing algorithm that is specific to the Korean culture (525). The algorithm may be an algorithm that parses only Korean names, or that parses all Asian names. However, such algorithms may not be available to the controller, so the controller passes the name phrases and the identified statistics to a generic algorithm for parsing names from all cultures. The generic algorithm uses the statistics to generate a parsed version of the name. The parsed version may indicate that the given name is “Kim Jae” and that the surname is “Dong.” The controller identifies a validity score for the parsed version of the name (535). Because “Kim” is found in the given name and “Dong” is found in the surname, the parsed version of the name may be given a low validity score, as described earlier. As a result, the controller may determine that the parsed version of the name is invalid (540).

The controller then reorders the name phrases (545). Because, “Jae” and “Dong” typically are found in given names, “Kim” typically is found in surnames, and given names typically appear before surnames (in the culture in which the controller is being used), the controller may reorder the name phrases such that “Jae” appears first, “Dong” appears second, and “Kim” appears third. The name is reparsed, and the new parsed version of the name may indicate that the given name is “Jae Dong” and that the surname is “Kim” (525). The controller identifies a validity score for the new parsed version (535). Because the three name phrases appear in fields of the new parsed version in which they typically appear, the new parsed version of the name may be given a high validity score. As a result, the controller may determine that the parsed version of the name is valid (540). The controller provides the parsed version of the name to the input/output module (550). The controller also may provide statistics describing the parsed version of the name to the input/output module (555).

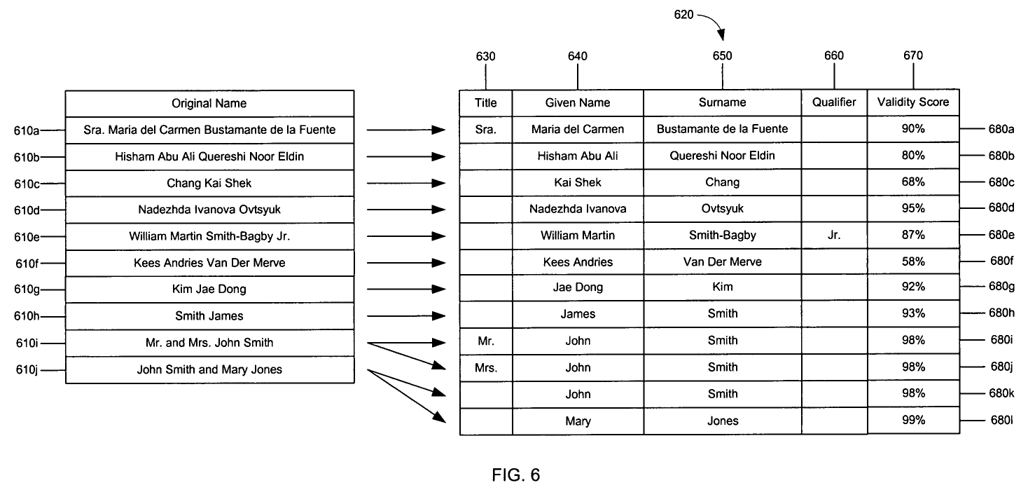

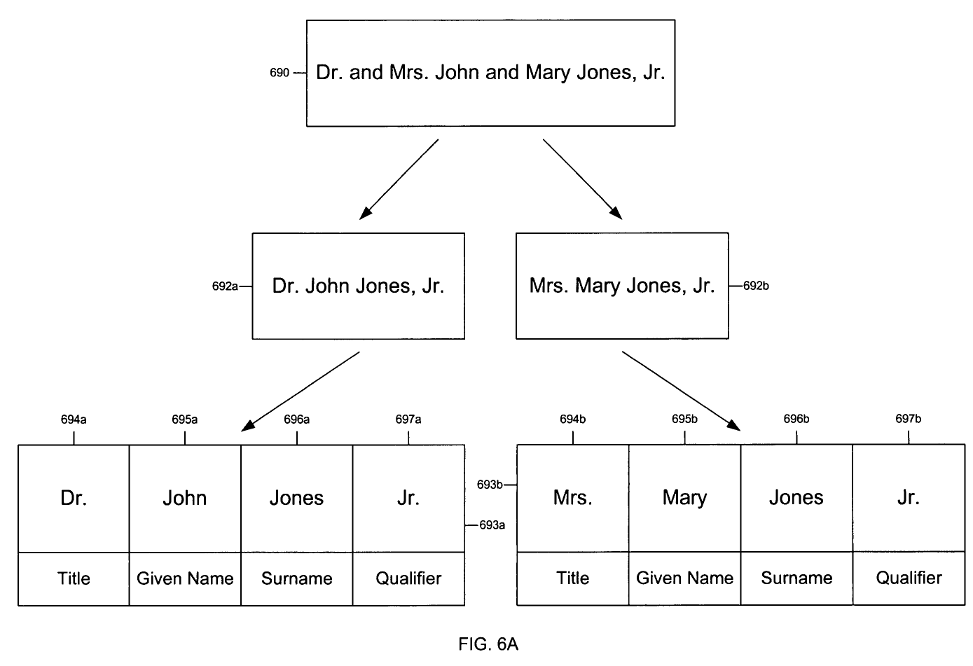

FIG. 6 provides examples that illustrate the application of process 500 using the name processing application 100 through the illustration of the parsing of exemplary names 610a-610j from multiple cultures. The parsed versions of the names 610a-610j are listed in a table 620 with columns 630-670. A title column 630 includes titles of the parsed names, a given name column 640 includes given names of the parsed names, a surname column 650 includes surnames of the parsed names, a qualifier column 660 includes qualifiers of the parsed names, and a validity score column 670 includes validity scores for the parsed names. In some implementations, the parsed names may be presented, for example, without the title column 630 or the qualifier column 660.

Each of the parsed names is represented by a row 680a-6801 in the table 620, and each of the names 610a-610j correspond to one or more of the rows 680a-6801. An arrow between one of the names 610a-610j and one of the rows 680a-6801 indicates that the row represents a parsed version of the name.

An empty cell in one of the rows 680a-6801 indicates that a corresponding one of the names 610a-610j does not include a name phrase of a type corresponding to the column of the empty cell. For example, the cell in the row 680b and the column 630 is empty because the corresponding name 610b does not include a title.

Several of the names 610a-610j have been parsed into given names and surnames that include multiple name phrases. Furthermore, each of the multiple name phrases may include multiple tokens, such as a name stem and one or more prefixes or suffixes. For example, the name 610a, “Sra. Maria del Carmen Bustamante de la Fuente” has been parsed into a given name that includes two name phrases and a surname that includes two name phrases. The given name “Maria del Carmen” includes the name phrases “Maria” and “del Carmen,” and “del Carmen” includes the name stem “Carmen” and the prefix “del.” Similarly, the surname “Bustamante de la Fuente” includes the name phrases “Bustamante” and “de la Fuente,” and “de la Fuente” includes the name stem “Fuente” and the prefixes “de” and “la.”

Most of the validity scores listed in the validity score column 670 exceed a minimum allowable validity score for corresponding parsed names to be valid, which may be 65%. Several of the names 610a-610j may have been parsed multiple times to identify parsed versions of the names with sufficiently high validity scores. Consequently, name phrases of those names were reordered each time the name was to be reparsed. In an implementation producing the results of the table 620, the name 610h, “Smith James” was parsed initially with “Smith” as the given name and “James” as the surname. Such a parse of the name 610h may lead to a low validity score, because “Smith” typically is found in surnames and “James” typically is found in given names. In the implementation, the name phrases of the name 610h may be reordered and reparsed such that “James” becomes the given name and “Smith” becomes the surname, as indicated in the row 680h. Such a parse of the name 610h has a higher validity score of 93%.

However, all names in which a surname appears before a given name are not parsed multiple times. For example, the row 680c indicates that the surname appears before the given name in the name 610c, and the row 680g indicates that the surname appears before the given name in the name 610g. A parsing algorithm used to parse the Asian names, of which the names 610c and 610g are examples, may recognize this typical structure and may correctly parse the names 610c and 610g such that sufficiently high validity scores of 68% and 92% are initially achieved.

Furthermore, some of the validity scores listed in the validity score column 670 do not exceed the minimum allowable validity score, even though the corresponding names were parsed multiple times. For example, the validity score for the parsed name in row 680f is 58%, which is less than the minimum allowable validity score, even though the name 610f was parsed multiple times. In an implementation producing the results of the table 620, an initial parse of the name 610f indicated that “Kees Andries” is the given name and that “Van Der Merve” is the surname, and such a parse received a validity score of 58%. In the implementation, reordering the name phrases of the name 610f and reparsing the reordered name 610f did not improve the validity score, so the initial order of the name phrases in the name is relied upon when identifying the initial parse as the better parse of the name 610f.

The names 610i and 610j are examples of conjoined name constructs. A conjoined name construct is a string that indicates multiple names that are joined by conjunctions. A conjoined name is one of the multiple names that are indicated by the conjoined name construct. For example, each of the names 610i and 610j indicates two conjoined names. Other examples of conjoined name constructs include “John and Mary Smith,” “Mr. and Mrs. John and Mary Smith,” and “John and Mary Smith and Robert Jones.” Typically, the number of surnames or given names in a conjoined name construct is less than the number indicated conjoined names. For example, the name 610i indicates two conjoined names, but includes only one surname. When a conjoined name construct is parsed, a parsed version of each conjoined name indicated by the conjoined name construct is produced. For example, when the name 610i is parsed, parsed names represented by the rows 680i and 680j are produced. Similarly, when the name 610j is parsed, parsed names represented by the rows 680k and 6801 are produced.

Referring to FIG. 6A, a conjoined name construct 690, “Dr. and Mrs. John and Mary Jones, Jr.,” indicates a name 692a, “Dr. John Jones, Jr.,” includes one or more tokens or punctuation marks that indicate multiple conjoined names that may be extracted from the conjoined name construct. The tokens may be conjunctions, such as “and” or “or,” and the punctuation marks may include, for example, an ampersand, a comma, or a semicolon. Such tokens may be referred to as separating elements of the conjoined name construct, because they may be used to separate the conjoined name construct into multiple indicated conjoined names.

The separating elements included in the conjoined name construct 690 may be used to extract two conjoined names 692a and 692b from the conjoined name construct 690. More particularly, the name phrases included in the conjoined name construct 690 are identified, for example, with the name phrase identifier 140 of FIG. 1. The identified name phrases do not include any of the separating elements included in the conjoined name construct 690. Each of the identified name phrases is classified as one of the possible types, for example, using statistics from the NDO 150 of FIG. 1. The classification of the name phrases and the locations of the separating elements indicate how the conjoined name construct is to be separated into the multiple conjoined names.

For example, if the name phrases on either side of a separating element are both titles (e.g., “Mrs. and Mrs. John Smith, Jr.”), then each title is grouped with the other given names, surnames, and qualifiers of the conjoined name construct (e.g., “Mr. John Smith, Jr.” and “Mrs. John Smith, Jr.”). As another example, when a separating element is preceded by a surname or a qualifier, and the separating element is followed by title or a given name (e.g., “John Smith, Jr. and Mary Jones”), then the separating element is assumed to be separating two complete conjoined names (e.g., “John Smith, Jr.” and “Mary Jones”).

As yet another example, if the name phrases on either side of a separating element are given names, (e.g., “John and Mary Smith, Jr.”), then each given name is grouped with the other surnames and qualifiers of the conjoined name construct (e.g., “John Smith, Jr.” and “Mary Smith, Jr.”). Conjoined names are identified similarly if multiple name phrases on either side of the separating element are given names (e.g., “John Peter and Mary Smith, Jr.” yields “John Peter Smith, Jr.” and “Mary Smith, Jr.”).

Furthermore, if the one or more given names on one side of the separating element is preceded or followed by a title (e.g., “Mr. John and Mary Smith, Jr.”), then the one or more given names and their associated title are grouped with the other surnames and qualifiers of the conjoined name construct (e.g., “Mr. John Smith, Jr.” and “Mary Smith, Jr.”). As another example, “Mr. John and Mrs. Mary Smith, Jr.” yields “Mr. John Smith, Jr.” and “Mrs. Mary Smith, Jr.” Rules may be also applied to the examine the parsed names for common exceptions, such as, for example, changing “Mary Smith., Jr.” to “Mary Smith”.

The above rules for identifying conjoined names from a conjoined name construct may be extended to apply to conjoined name constructs that include multiple separating elements. For example, the rule for separating a conjoined name construct that includes given names on either side a separating element may be extended to apply to separating a conjoined name construct that includes three or more given names that are separated by two or more separating elements (e.g., “Tom, Dick and Harry Smith”). In such a case, each given name is grouped with the other surnames and qualifiers of the conjoined name construct (e.g., “Tom Smith,” “Dick Smith,” and “Harry Smith”).

Other rules are specific only to conjoined name constructs that include multiple separating elements. For example, if name phrases on either side of a first separating element are titles, and if name phrases on either side of a second separating element are given names, as is the case in the conjoined name construct 690, the conjoined name construct represents a parallel construction. In such a case, the first title is grouped with the first given name, as well as the other surnames and qualifiers of the conjoined name construct, and the second title is grouped with the second given name and the other surnames and qualifiers, as is indicated by the names 692a and 692b.

As another example, in conjoined name constructs with multiple separating elements, a determination of whether a particular one the separating elements is separating two complete conjoined names, each of which may represent a conjoined name construct themselves, is made. If that is the case, then the name is separated into the two conjoined names at the particular separating element. Each of the two conjoined names is processed recursively to determine whether the conjoined name represents a conjoined name construct, and, if so, to identify the conjoined names that are indicated by the conjoined name construct, using the rules described above. For example, in the name “John and Mary Smith and Bob and Linda Jones,” the second “and” separates two conjoined names, “John and Mary Smith” and “Bob and Linda Jones.” Both of the conjoined names include a separating element (e.g., “and”), so both of the conjoined names represent conjoined name constructs. Therefore, the two conjoined names are processed using the above rules to determine that the original conjoined name construct indicated four conjoined names, “John Smith,” “Mary Smith,” “Bob Jones” and “Linda Jones.”

The above rules do not require that titles appear before given names in the conjoined name construct, that given names appear before surnames, or that surnames appear before qualifiers to identify the indicated conjoined names. However, when grouping the name phrases into the conjoined names, titles appear first, followed by given names, surnames, and qualifiers. Therefore, the conjoined name construct “Smith John Mr. and Mrs.” yields the conjoined names “Mr. John Smith” and “Mrs. John Smith.” Furthermore, when grouping name phrases of the conjoined name construct to form the conjoined names, the order of name phrases of the same type in the conjoined name construct is maintained in the conjoined names.

After the conjoined names have been identified, each of the conjoined names is parsed. For example, parsing algorithms that are specific to cultures of each of the conjoined names may be used to parse the conjoined names. As a result, name phrases of the conjoined names are parsed into each of the possible element types. For example, the names 692a and 692b are parsed individually to produce parsed names 693a and 693b, respectively. The parsed names 693a and 693b include titles 694a and 694b, given names 695a and 695b, surnames 696a and 696b, and qualifiers 697a and 697b, respectively.

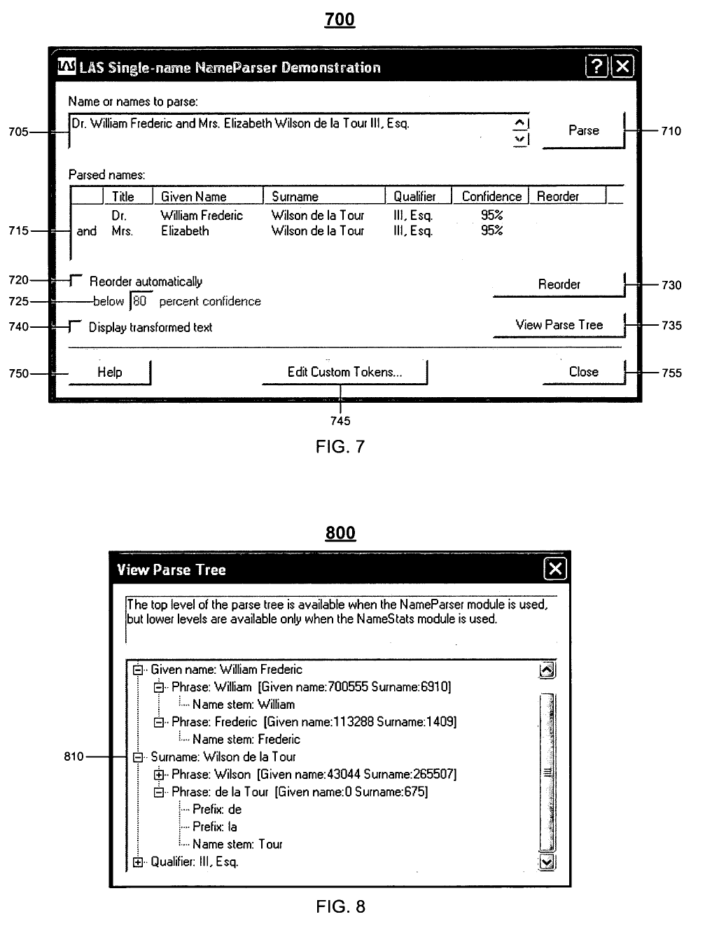

Referring to FIG. 7, a parsing interface 700 enables a user to specify one or more personal names to be parsed and to view parsed versions of the personal names. The interface 700 also enables the user to specify values for one or more parameters to control how the names are parsed. The parsing interface 700 may represent an input/output module of a name processing application, such as the input/output module 10 of the name processing application 100.

The parsing interface includes an input field 705 into which one or more names to be parsed are entered. Multiple individual names may be entered into the input field 705 if they are separated by particular punctuation marks, such as a comma or a semicolon. In addition, one or more conjoined name constructs may be entered into the input field 705. In the illustrated interface 700, the conjoined name construct “Dr. William Frederic and Mrs. Elizabeth Wilson de la Tour III, Esq.” has been entered into the input field 705.

Selecting a parse button 710 signals for the names included in the input field 705 to be parsed. In other words, selecting the parse button 710 passes the names to be parsed to a parsing controller of the name processing application, such as the parsing controller 120. The parsing controller uses other components of the name processing application to create parsed versions of the names. The parsed versions are passed to the input/output module and displayed in an output field 715. The output field 715 is a table that includes columns for titles, given names, surnames, and qualifiers of the parsed names. Each of the parsed names is given a row in the table, and the components of the parsed names are spread among the columns accordingly. For example, two conjoined names were indicated by the conjoined name construct that was entered into the input field 705, so two parsed names are displayed in the output field 715. The first parsed name has “Dr.” as a title, “William Frederic” as a given name, “Wilson de la Tour” as a surname, and “III, Esq.” as a qualifier, and the second parsed name has “Mrs.” as a title, “Elizabeth” as a given name, “Wilson de la Tour” as a surname, and “III, Esq.” as a qualifier. Each row also includes an indication of the validity score or confidence of the corresponding parsed name. In the illustrated interface 700, both parsed names have validity scores of 95%, which indicates that the parsed names are considered to be valid.

A reorder checkbox 720 enables the user to indicate that name phrases of a name that has been entered into the input field 705 should be reordered and reparsed automatically when a previous parse of the name has a validity score below a threshold value. The threshold value may be specified in a text field 725. In one implementation, the user may specify the threshold value in the text field 725 only after the checkbox 720 has been selected. A reorder button 730 enables a user to indicate manually that a name should be reparsed. For example, the user may view a parsed version of a name and an associated validity score in the results field 715. After manually determining that the parse is invalid because the validity score is too low, the user may select the reorder button 730 to reorder the name phrases of the name, to reparse the name, and to receive another parse of the name.

A parse tree button 745 causes an interface displaying a parse tree for a parsed name that has been selected from the results field 715 to be displayed. The parse tree indicates the types of name phrases in the parsed name, as well as components of the included name phrases. The parse tree also indicates numbers of names in which the name phrases appear as given names and surnames, as indicated by a corresponding NDO, such as the NDO 150.

Referring also to FIG. 8, an interface 800 displays a parse tree 810 for the first parsed name listed in the results field 715. Only a portion of the parse tree 810 is visible in the interface 800. More particularly, the parse tree 810 indicates the name phrases, and the components thereof, that are included in the given name and the surname of the parsed name.

The parse tree 810 indicates that the given name “William Frederic” includes two name phrases. The name phrase “William” is included in 700,555 names as a given name, and in 6,910 names as a surname. The name phrase includes a single component, namely the name stem “William.” Similarly, the parse tree 810 indicates that the surname “Wilson de la Tour” includes two name phrases. The name phrase “Wilson” has only one component, and the name phrase “de la Tour” has three components. The parse tree 810 indicates that “Tour” is the name stem for the second name phrase, and that “de” and “la” are prefixes to the name stem. Invisible portions of the parse tree 810 indicate that the title includes a single name phrase that includes a single title (e.g., “Dr.”). In addition, the invisible portions of the parse tree 810 indicate that the qualifier includes two name phrases, each of which includes a single qualifier (e.g., “III” and “Esq.”).

Referring again to FIG. 7, a transformed text checkbox 740 enables a user to indicate that the parsed names should be presented in the results field 715 without formatting. For example, when the checkbox 740 is selected, the parsed names may be presented in the results field 715 in uppercase letters without punctuation, accents, or noise characters, or characters that are not included in the parsed names. Presenting or providing the parsed names without formatting may enable the parsed name to be viewed or used by users or systems that are not configured to recognize the formatting.

A custom tokens button 745 enables a user to specify additional tokens or name phrases to be added to the NDO used by the name processing application. When the custom tokens button 745 is selected, an interface with which the user may specify the additional tokens or name phrases is displayed. The interface enables the user to specify a name phrase, numbers of names in which the name phrase is each of the possible types, as well as a comment for the name phrase. In addition, the interface also enables specification of one or more noise filters. A noise filter includes words that are ignored when included in names being parsed. A noise filter may indicate that words that typically are not included in names be ignored. For example, when parsing the name “Thomas P. “Tip” O'Neill, Jr.,” a noise filter may indicate that words within quotation marks (e.g., “Tip”), which typically represent nicknames, are to be ignored.

A help button 750 enables a user to receive help when using the interface 700. Selecting the button 750 causes a help interface that describes how to use the interface 700 to be displayed to the user. A close button 755 dismisses the interface 700 when selected.

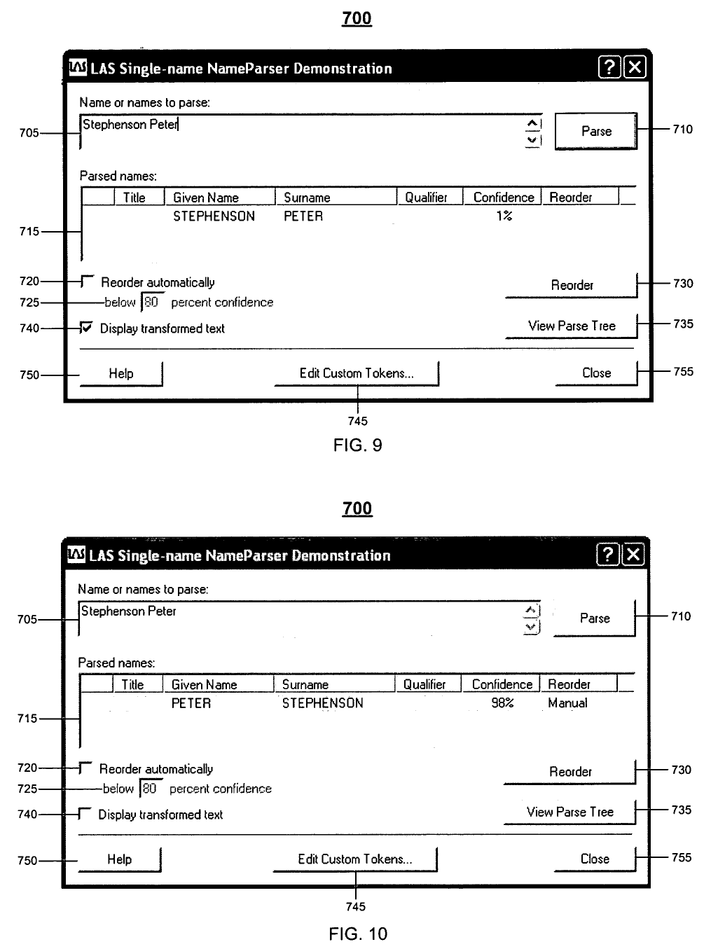

Referring also to FIG. 9, name phrases of a name entered into the input field 705 of the interface 700 may be reordered to correctly parse the name. For example, the name “Stephenson Peter” has been entered into the input field 705. That name includes two name phrases, namely “Stephenson” and “Peter,” and each of the name phrases is typically found in English names. In English names with two name phrases, the first name phrase typically is a given name, and the second name phrase typically is a surname. Therefore, the name may be parsed such that “Stephenson” is the given name and “Peter” is the surname, as in indicated in the results field 715.

However, row 270m of the statistics table 200 and row 370y of the statistics table 300 indicate that the name phrase “Stephenson” appears more frequently as a surname. In addition, row 270n of the statistics table 200 and row 370z of the statistics table 300 indicate that the name phrase “Peter” appears more frequently as a given name. Therefore, the initial parse of the name that is listed in the results field 715 may be invalid, as is indicated by the relatively low confidence or validity score (1%) assigned to the initial parse.

Referring to FIG. 10, selecting the reorder button 730 rearranges the two name phrases of the name “Stephenson Peter.” Because the name includes only two name phrases, the name may be reordered in only one manner, and the name is parsed as if entered originally as “Peter Stephenson.” Using the conventional rules for English names, “Peter” is identified as the given name, and “Stephenson” is identified as the surname, as is indicated in the results field 715. This is corroborated by the information included in the statistics tables 200 and 300, which results in the high validity score of 98% assigned to the parsed name.

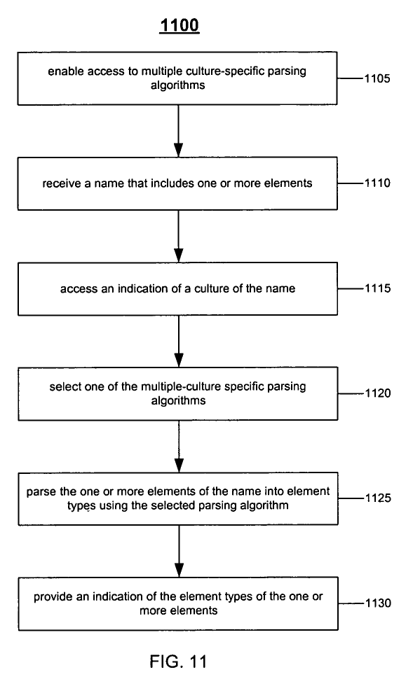

Referring to FIG. 11, an alternative process 1100 also may be used to parse culturally diverse names. The process 1100 is similar to the process 500. The process 1100 may be executed by a name processing application, such as the name processing application 100.

The name processing application enables access to multiple culture-specific parsing algorithms (1105). Each of the culture-specific parsing algorithms parses names of one or more corresponding cultures. For example, a German parsing algorithm may parse German names, while an Asian parsing algorithm may parse Chinese, Japanese, and Korean names.

The name processing application receives a name that includes one or more elements (1110). The name may be received, fox example, from a UI for the name processing application, or through invocation of a method of an API that is implemented by the name processing application.

The name processing application accesses an indication of a culture of the name (1115). The name processing application may identify the culture based on at least one characteristic of the name. The name processing application selects one of the multiple culture-specific parsing algorithms (1120). More particularly, the name processing application selects the culture-specific parsing algorithm that corresponds to the indicated culture. For example, if the indicated culture is German, the algorithm for parsing German names may be selected. As another example, if the indicated culture is Korean, the algorithm for parsing Asian names may be selected.

The name processing application parses the one or more elements of the name into element types using the selected parsing algorithm (1125). More particularly, the name processing application classifies each of the elements of the names as one of the possible types. The classification of the elements may be based on characteristics of names of the indicated culture. The classification also may be based on statistics describing the elements of the name, such as the information that is accessible from the NDO 150 of FIG. 1.

The name processing application provides an indication of the element types of the one or more elements (1120). The name processing application may provide the indication of the element types through the UI or API from which the name was received.

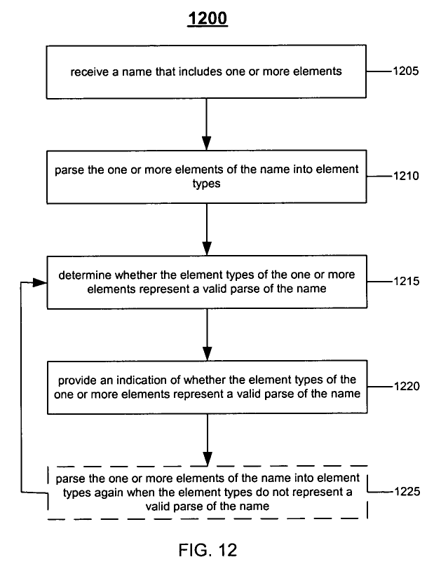

Referring to FIG. 12, a process 1200 is used to identify valid parses of names. If a valid parse of a name is not identified initially, the name may be parsed again. The process 1100 may be executed by a name processing application, such as the name processing application 100.

The name processing application receives a name that includes one or more elements (1205). The name may be received, fox example, from a UI for the name processing application, or through invocation of a method of an API that is implemented by the name processing application.

The name processing application parses the one or more elements into element types (1210). More particularly, the name processing application may parse each of the elements of the names as one of the possible types. The classification may be based on statistics describing the elements of the name, such as the information that is accessible from the NDO 150 of FIG. 1. The name processing application may parse the one or more elements with or without reference to a culture of the name. If the elements are parsed with reference to the culture, the elements may be parsed using an algorithm that parses names of the culture based on characteristics of names of the indicated culture.

The name processing application determines whether the element types of the one or more elements represent a valid parse of the name (1215). The name processing application may make such a determination by identifying a validity score for the parsed version of the name. In one implementation, the name processing application uses a validity checker, such as the validity checker 170 of FIG. 1, to identify the validity score. A validity score that exceeds a threshold (or a previous score) may indicate that the parsed version is valid, and a validity score that is less than or equal to the threshold (or a previous score) may indicate that the parsed version is not valid.

The name processing application provides an indication of whether the element types of the one or more elements represent a valid parse of the name (1220). The name processing application may provide the indication of the element types through the UI or API from which the name was received.

The name processing application also may parse the one or more elements of the name into element types again when the element types do not represent a valid parse of the name (1225). Before doing so, the name processing application may reorder the elements of the name, as described above. After the elements have been parsed again, the name processing application may determine whether the new parse of the name is valid (1210). In this manner, the name may be parsed repeatedly until, for example, a valid parse is identified, or until a new parse that is more valid that a previous parse is not identified.

The NDO 150 is described throughout as including, for each name phrase that appears in a set of names, numbers or counts of the names that include the name phrase as each of the possible types of name phrases. However, in another implementation, the NDO may include percentages of the names in the set that include the name phrase in general. In addition, the NDO may maintain percentages of the names that include the name phrase in general that include the name phrase as each of the possible types. In another implementation, the NDO may maintain other indications of the frequency with which the name phrase appears in general and as each of the possible types in the set of names.

The described techniques may be applied in batch mode processing of a set of names. In other words, multiple names may be parsed without receipt of a separate indication from the user that each of the names should be parsed. For example, an input file may include a list of names to be parsed. In response to a single action by the user, the described techniques may be used to individually parse each name in the input file. Parsed versions of each name may be listed in an output file that the user may access. In one implementation, the user may be enabled to specify a format in which the names to be parsed are specified in the input file, or a format in which the parsed names are listed in the output file. The user also may indicate whether names are to be reparsed automatically when a previous parse is invalid. The user also may be enabled to specify custom name phrases to be added to the NDO that is used to parse the names included in the input file.

The described systems, methods, and techniques may be implemented in digital electronic circuitry, computer hardware, firmware, software, or in combinations of these elements. An apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for parsing names, the method comprising:
enabling access to multiple parsing algorithms for parsing name elements into one or more types of elements, the multiple parsing algorithms including separate parsing algorithms that respectively correspond to at least one of multiple known cultures;
receiving a name that includes one or more elements;
accessing, for the name, an indication of at least one culture from among the multiple known cultures;
selecting one of the multiple parsing algorithms based on the indication of the culture of the name;
parsing the one or more elements of the name into element types using the selected parsing algorithm; and
providing an indication of the element types of the one or more elements.

2. The method of claim 1 wherein accessing the indication of the culture of the name comprises:
detecting a characteristic of at least one of the elements of the name; and
determining the indication of the culture of the name based on the characteristics detected.

3. The method of claim 1 further comprising accessing a database providing a statistical indication of a type of an element, and wherein parsing is also based on the statistical indication.

4. The method of claim 1 further comprising determining a validity score for the parsing of the elements.

5. The method of claim 4 further comprising:
comparing the validity score to a threshold; and
determining whether to reorder the one or more elements based on a result from the comparing.

6. The method of claim 4 further comprising
determining to reorder the one or more elements based on the validity score;
accessing a database providing statistical indications of the types of the one or more elements; and
reordering the one or more elements using the statistical indications.

7. The method of claim 6 further comprising parsing the reordered elements of the name into element types using the selected parsing algorithm.

8. The method of claim 4 further comprising providing an indication of the validity score.

9. The method of claim 1 wherein parsing the one or more elements of the name into element types comprises classifying each of the one or more elements as a title, a given name, a surname, or a qualifier.

10. The method of claim 1 further comprising providing statistics describing at least one of the one or more elements of the name.

11. The method of claim 1 wherein receiving the name comprises receiving a personal name.

12. A method for identifying a valid parse of a name, the method comprising:
receiving a name that includes one or more elements;
parsing the one or more elements of the name into element types;
determining whether the element types of the one or more elements represent a valid parse of the name; and
providing an indication of whether the element types of the one or more elements represent a valid parse of the name.

13. The method of claim 12 wherein determining whether the element types represent a valid parse of the name comprises determining a validity score for the element types.

14. The method of claim 13 further comprising:
comparing the validity score to a threshold; and
determining whether to reorder the one or more elements based on a result from the comparing.

15. The method of claim 13 further comprising
determining to reorder the one or more elements based on the validity score;
accessing a database providing statistical indications of the types of the one or more elements; and
reordering the one or more elements using the statistical indications.

16. The method of claim 15 further comprising parsing the reordered elements of the name into element types.

17. A method for processing a name, the method comprising:
receiving an indication of a name that includes multiple tokens;
accessing an indication of a culture of the name;
identifying one or more name phrases included in the name based on the culture of the name, at least one of the identified name phrases having more than one token;
designating the identified name phrases as an input to a subsequent name processing operation; and
processing the name using the identified name phrases as an input to the subsequent name processing operation.

18. The method of claim 17 wherein processing the name comprises parsing the name.

19. The method of claim 17 wherein identifying the one or more name phrases comprises:
classifying each of the multiple tokens in the name as a prefix, suffix, or stem based on the culture of the name; and
grouping the classified tokens into name phrases based on the classification of the tokens and the culture of the name.

20. A method for parsing a conjoined name, the method comprising:
receiving a conjoined name construct that includes multiple elements;
identifying multiple names indicated by the conjoined name construct, each of the multiple names including one or more elements, at least one of the multiple elements of the conjoined name construct being included as an element in each of the multiple names;
parsing the one or more elements of at least one name of the multiple names into element types; and
providing an indication of the element types of the one or more elements of the at least one name.

21. The method of claim 20 further comprising:
enabling access to multiple parsing algorithms for parsing name elements into one or more types of elements, the multiple parsing algorithms including separate parsing algorithms that respectively correspond to at least one of multiple known cultures;
accessing, for the at least one name, an indication of at least one culture from among the multiple known cultures; and
selecting one of the multiple parsing algorithms based on the indication of the culture of the at least one name;
wherein parsing the one or more elements of the at least one name comprises parsing the one or more elements using the selected parsing algorithm.

22. The method of claim 20 further comprising accessing a database providing a statistical indication of a type of an element of the at least one name, and wherein parsing is also based on the statistical indication.
